(19) United States
(12) Patent Application Publication
(10) Pub. No.: US 2002/0106615 A1
(43) Pub. Date: Aug. 8, 2002

(54) Method for creating and executing self-directed study courses

(76) Inventors: Madelon L. Murray, Costa Mesa, CA (US); Donald R. Jacobs, Costa Mesa, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/055,495

(22) Filed: Oct. 19, 2001

Related U.S. Application Data
(63) Continuation of application No. 09/474,859, filed on Dec. 30, 1999, now abandoned.

(51) Int. Cl. G09B 19/00

(52) U.S. Cl. 434/156

(57) ABSTRACT

A step-by-step method defines a procedure for preparing and executing a course of study executed by a student located remotely with respect to a course administrator. The method enables the preparation and packaging of the course in a form for delivery to a student. In one embodiment, the course requires travel by the student to a remote geographical location wherein at least a portion of the study elements included in the course of study are fixed at the remote location. In another embodiment, the course of study is administered over the Internet. In still another embodiment of the present invention, the course is completed exclusively at home.

This application is a continuation of Ser. No. 09/474859 filed on Dec. 30, 1999 and contains no new matter relative thereto.

### BACKGROUND OF THE INVENTION

1. Field of the Invention

This invention relates generally to methods for creating or establishing educational materials, and more particularly to a method for creating study courses for use in a program of self-directed study.

2. Description of Related Art

Clearly, home study courses, commonly referred to as “correspondence courses or independent study courses,” in many subject areas have been made available to the general public for many years. More recently, the term “distance learning” has become popular in the education industry and is in widespread use by many educational facilities in this country. Shortly after the introduction of consumer television, this medium became popular for educational purposes and today is widely used for distance learning. With the growing widespread acceptance and ease of the Internet, again, a major educational opportunity exists for distance learning and exposure to the general public of vast amounts of information.

A technical paper entitled, “Open Learning Initiative Consultation Paper,” dated January, 1997 and prepared by Richard Hook of the OLI Steering Committee of Humber College Online, is incorporated into this application by reference. A copy of this paper is made a part of the prior art submitted with this application. In this paper, Mr. Hook states as follows” “Over the years, education has for the most part required the teacher and student to meet together in a physical location at a set time to study a prescribed curriculum. This tradition of education has meant that education is out of reach for segments of the population. With education becoming more important for adult learners as the means to a job, keeping a job or job advancement, as well with greater time demands for all and the difficulty of physically getting to a classroom (time, distance, emotional stress), more and more adults are seeking learning opportunities of greater personal convenience. With the enormous changes in communications and technology, it is possible to develop learning enviromnents that are available for the student at his/her time and convenience. In the field of education curriculum and course development are important subjects.”

Mr. Hook discusses models and examples of open learning, principles of distance learning, and relevant policy and procedural issues. Although this paper is directed to defining opportunities and appropriate directions for Humber College, it may be understood in a greater sense as a model of the present state of understanding and direction in the art of distance learning in the field of education in general an d therefore provides an insight into the state of this art at the present time.

U.S. Pat. No. 5,173,051 discloses a curriculum planning end publishing method and system in which large quantities of information may be arranged to produce a customized learning tool. This tool may embody a variety of formats ranging from a simple book to a computer and video multisensory presentation. Providing a customized learning experience maximizes effective learning time, places the teacher in better control of the classroom; and allows a school or school district to cater to the needs of the community while maintaining a uniform curriculum.

University of Phoenix Online, is a reference sited during prosecution of the parent case, Internet, (pp. 1-7) and teaches the steps of studying the subject related materials, grading the examination result for establishing academic credit and issuing a grade for credit. This reference fails to teach determining a course objective and preparing a course outline. These steps are not taught in the prior art in conjunction and combination with the other steps shown in a sequenced manner in the present invention method.

The prior art teaches the use of distance learning. However, the prior art does not teach that a standard course development and implementation method of the type of the present invention may be employed to provide a powerful tool for self-development. The present invention fulfills these needs and provides further related advantages as described in the following summary.

### SUMMARY OF THE INVENTION

The present invention teaches certain benefits in construction and use which give rise to the objectives described below.

The present invention provides a step-by-step method defining a procedure for preparing and executing a course of study where such course is taken by a student located remotely and through self direction and management with respect to a course guide. The method is of statutory subject matter under 35 USC 101 in that it falls into the aegis defined by the State Street Bank decision, as it enables the preparation and packaging of the course, which then is delivered to the student at such time as the student is best prepared for receiving it, and such delivery is preferably via mail, package delivery service or via the Internet. In all instances, once the course materials have been delivered to the student, the course is self-conducted by the student in accordance with general instructions. In one embodiment, the course requires travel by the student to a remote geographical location wherein at least a portion of the course's study elements are located and the course is self-conducted, at least partly, at the remote location. In another embodiment, the course is completed entirely within a home environment. In a third embodiment the course is uploaded to the student electronically as, for instance, via the Internet.

A primary objective of the present invention is to provide a process for the development of a remote learning course of study and its execution having advantageous features and constructional elements not taught by the prior art.

Another objective is to provide such a method wherein the student has control over both quality and rate of learning, i.e., quality of the learning experience is a student-controlled parameter in distance learning, as it always is with self-taught studies, and rate of learning is under the student's control as determined by the amount of time invested.

A further objective is to provide such a method wherein the primary source of information related to the course of study is located at a geographical site unrelated to the course provider and the student.

A yet further objective is to provide such a method wherein key study materials are derived through interviews with knowledgeable individuals, especially historians, specialists, professionals and those with long life experience in a related geographical site.

A still further objective is to provide such a method wherein the course of study is administered via the Internet.

Other features and advantages of the present invention will become apparent from following more detailed description, which describes the principles of the invention.

### DETAILED DESCRIPTION OF THE INVENTION

A method for preparing study courses comprises the sequential steps of: (1) identifying a course theme, said theme being derived from any subject of interest such as the critical issue of the effects of divorce on children, or an historically significant location such as Alaska as the 49^{th} state; (2) collecting subject-related research materials relevant to the course theme such as books and video lists, audio supplier catalogs, resources found through research on the Internet, contacting chambers of commerce, historical societies and appropriate intellectuals and/or experts on the course theme; (3) studying the theme-related materials in order to extract definitive course direction, understanding, focus and scope, such as, in the case of the effects of divorce on children, how a teacher would watch for signs of emotional distress in a child; or in the case of Alaska, focusing on the Russian era and its historical and corresponding current effects; (4) determining at least one course objective so as to inform, alarm, motivate, prepare, educate, develop or otherwise increase the level of skill, knowledge or potential of the student, such as in the case of the effects of divorce on children, providing the student with specific classroom exercises, materials and/or information that will enable the student, usually a teacher, to counsel a distressed child in a caring, compassionate environment; or in the case of Alaska, providing the student with exercises, materials and/or information that will provide for a better understand and, thus, be better prepared to teach the effects and importance of the Russian era, and to prepare a course outline calculated for achieving at least one of the course's objectives; (5) selecting study materials in accordance with the course emphasis and objectives, said materials being derived from the subject-related research materials, primary research results, secondary, or derivative research and any other related source of consequence, such as in the case of effects of divorce on children, materials may have been gathered relating to step-parenting but not included with the course because it may be better served as part of a separate course, or because it is not supportive of the course objectives as more narrowly construed, whereas information on emotions and conflict may be included because it is related to a child's behavior in the divorce situation; or, in the case of Alaska, materials may have been accumulated on the Eskimos but excluded from this course because it might be more effectively addressed in a course specifically directed to the Eskimo, while materials and information on the great oil impact is better included because it was an issue when purchase from Russia was being considered; (6) establishing a course study guide for use by the student for providing the student with a means for study progress control and the use of the study materials, which study guide includes a list of the included materials and related assignments, instructions on the completion of the assignments, and suggestions on the order of completion; (7) establishing a course examination program such as one or more sets of subject-related questions or essays, to facilitate the acceleration of student awareness and study progress and for qualitative student evaluation upon course completion, such as in the case of effects of divorce on children, a multi-page set of questions derived from a course text would be created in the form of “fill in the blanks” type questions, or require subjective written responses, while in the case of the Alaska course, an assignment essay relating to a course video might be required; (8) packaging the study materials, study guide and examination program into a defined package for distance carrier physical delivery to the student, such as in the case of a ground delivery, such packaging would be protective materials such as a cardboard box, bubble-wrap envelope or any appropriate materials to ensure damage-free or loss-free delivery to the student; (9) delivering the package to a student via a commercial delivery service, post or electronically via the Internet, for initiation of the study course; (10) completion of the study course by the student in accordance with the study guide; (11) completion of the examination program by the student for establishing an examination result; (12) return of the examination program by the student via commercial delivery, post, or electronically to a qualified instructor for the purpose of evaluation and grading, (13) grading of the examination program results by the qualified instructor for establishing professional development, academic, college or other educational credit, and (14) issuing grades and academic credit based upon the evaluation criteria determined by the a credit issuing institution, as for example an accredited university.

In the above steps, the subject-related research materials are preferably taken from the subject group comprising historical, cultural, scientific, governmental, commercial, and sports related materials. However, the materials and, indeed, the theme of the course may be taken from any area of human endeavor or knowledge that may be advantageously utilized in the manner of the present method. Inventively, the course study guide preferably includes at least the list of study materials, a preferred sequence of study activities, an estimated time duration required for each of the study activities, and for the course per se, and a summary of student proficiency expectation upon course completion and how such proficiency relates to at least one beneficial accreditation scale, as for example, how the completion of such a course relates to the professional advancement potential of the student.

The study materials preferably include and are established from at least one of the group of information sources comprising: books, pamphlets, papers, audio and, or video tapes, computer storage disks and related media, photographs and other graphic media, manuscripts and Internet materials in a form for being used hands-on or on-line for advantageous downloading for student convenience. The examination program includes the study materials, the sequence of study activities formed as a related and suggested proposal, and in certain instances, the expense requirements for each of the study activities, a summary of student proficiency expectation upon course completion and how such proficiency relates to at least one beneficial accreditation scale, and at least one written test comprising questions and, or essay requirements taken from the subject matter of the course.

A further embodiment of the instant inventive method provides a course theme related to a specific geographical location such as a region, park, monument or a city, or other specific place where such place has related to it ail historic or other feature that is of human interest. In this embodiment, the method comprises the additional step of traveling to the geographical location for collecting subject-related research materials relevant to the geographical location. Such subject related research materials preferably include graphical and related written representations of the location, its history, culture and other related features and expressions. The study materials in this case include at least some of the features and other important or characteristic elements of the geographical location in accordance with the course theme and within the at least one course objective.

Completion of the latter method of study by the student is accomplished in accordance with the study guide and includes, as mentioned above, travel by the student to the geographical location and detailed study of its salient features during such visit. The study materials preferably include written representations of the geographical location. The course examination program includes, but is not limited to, student presentation of at least one artifact which could be in the form of photographs, rubbings, receipts for admission fees, or specific tokens taken from the geographical location as a means for demonstrating that a visit to the location was in fact accomplished.

The collecting of subject-related research materials relevant to the geographical location inventively may also include at least one interview of at least one aged, historically knowledgeable, or appropriately expert person for documenting relevant anecdotal and/or verifiable commentary. This step is considered to be of importance in that much of the recent history and knowledge of a place or location is not available in a written form to the researcher, as for instance: tapes, photographs, books, brochures or other writings. A deeper understanding of a place, its people, history, culture, events and related human drama are typically only available from those who have lived in a place and taken part in that drama. An example of the importance of this type of method of study in a course would be in the case of the Alaska History course, discussed previously, wherein an elderly person of Russian descent still living in Alaska might be available and willing to be interviewed by audio tape to relate personal experiences and insights that affected that person, his or her family, culture, and future as a prototype related to the more general experience at that site.

In a third embodiment of the instant invention method the course is prepared for execution via the Internet. In this case the study materials, study guide and examination program are placed into programs on a designated Internet site in a, manner that is accessible to the student. Upon access by the student the study course is used by the student to complete the objectives of the course, take the appropriate test or tests and receive credit for the experience.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for preparing study courses, the method comprising the sequential steps of:
a) selecting a course theme;
b) collecting theme related research materials;
c) studying the theme related materials;
d) determining at least one course objective;
e) preparing a course outline directed to achieving the at least one course objective;
f) selecting study materials in accordance with the course outline and the at least one course objective,
g) establishing a course study guide enabled for directing a student progress control in the use of the study materials;
h) establishing a course examination program enabled for establishing student awareness of study progress and for qualitative student evaluation upon course completion;
i) packaging the study materials, study guide and examination program into a package for distance physical delivery;
j) delivering the package to a student for completion of the study course against payment therefore;
k) completing the study course by the student in accordance with the study guide;
l) completing the examination program by the student for establishing an examination result;
m) returning of the completed examination for evaluation and grading,
n) grading of the examination result for establishing academic credit; and
o) issuing a grade and academic credit.

2. The method of claim 1 at step (b) wherein the subject-related research materials are selected from the subject group consisting of historical, cultural, scientific, technical, governmental, commercial, and sports.

3. The method of claim 1 at step (e) the preparation of the course outline includes documenting: study materials, a sequence of study activities, an estimated time duration required for each of the study activities and for the course per se, and a summary of student proficiency expectation upon course completion and how such proficiency relates to at least one beneficial accreditation scale.

4. The method of claim 1 wherein the selecting of study materials of step (f) includes incorporating the study materials in at least one of the group of information sources comprising: books, pamphlets, tapes, computer storage disks, photographs, manuscripts and Internet materials in a form for being used on-line and downloaded.

5. The method of claim 3 wherein in step (g), establishing the course study guide, includes preparing and documenting a list of study materials, a sequence of study activities formed as a study proposal, an estimated time duration required for the course per se, an evaluation criteria sheet, a time log and a summary of student proficiency expectation upon course completion and how the course relates to at least one beneficial accreditation scale.

6. The method of claim 1 wherein in step (h) the establishing of a course examination program includes documenting at least one written test for testing knowledge of the subject matter of the course.

7. A method for preparing study courses, the method comprising the sequential steps of:
a) identifying a course theme related to a specific geographical location;
b) traveling to the geographical location;
c) collecting subject-related research materials relevant to the geographical location said subject-related research materials including graphical representations;
d) evaluating the subject-related materials;
e) determining at least one course objective;
f) preparing a course outline calculated for achieving the at least one course objective;
g) preparing study materials in accordance with the course outline and the at least one course objective;
h) establishing a course study guide enabled for providing a student with a means for progress control in the use of the study materials;
i) establishing a course examination program enabled for the facilitation of student awareness of study progress and for qualitative student evaluation upon course completion;
j) packaging the study materials, study guide and examination program into a package for physical carrier delivery;
k) delivering the package to a student for completion of the study course;
l) completing the study course by the student in accordance with the study guide including travel by the student to the geographical location;
m) completing the examination program by the student, establishing an examination result;
n) grading of the examination result for establishing academic credit; and
o) issuing a grade and academic credit.

8. The method of claim 7 wherein in step (b) the subject related research materials are selected from the subject group consisting of historical, cultural, scientific, governmental, commercial, and sports.

9. The method of claim 7 wherein in step (c) the collecting of subject-related research materials relevant to the geographical location includes at least one interview of at least one aged person for documenting relevant anecdotal commentary.

10. The method of claim 7 wherein in step (e) the course outline includes listing: study materials, a sequence of study activities, an estimated time duration required for each of the study activities and for the course per se, and a summary of student proficiency expectation upon course completion and how such proficiency relates to at least one beneficial accreditation scale.

11. The method of claim 7 wherein the study materials of step (f) are prepared by incorporating the study materials in at least one of the group of information sources comprising: books, pamphlets, tapes, computer storage disks, photographs, manuscripts and Internet materials in a form for being used on-line and downloaded.

12. The method of claim 10 further including in step (g), the study guide includes the listing of study materials, the sequencing of study activities formed as a proposal, the estimating of a time duration required for each of the study activities and for the course per se, an evaluation criteria sheet, a time log and summarizing of student proficiency expectation upon course completion and ]low such proficiency relates to at least one beneficial accreditation scale.

13. The method of claim 7 further including in step (h) of the course examination program, at least one written test of the subject matter of the course and at least one artifact taken from the geographical location.

14. A method for preparing study courses, the method comprising the sequential steps of:
a) identifying a course theme;
b) collecting subject-related research materials relevant to the course theme;
c) studying the subject-related materials;
d) determining at least one course objective;
e) preparing a course outline calculated for achieving the at least one course objective;
f) establishing study materials in accordance with the course outline and the at least one course objective,
g) establishing a course study guide for providing a student with a means for student progress control in the use of the study materials;
h) establishing a course examination program to facilitate student awareness of study progress and for qualitative student evaluation upon course completion;
i) placing the study materials, study guide and examination program onto the Internet in a manner enabled for uploading to a student electronically;
j) downloading of the study materials from the Internet by the student for completion of the study course;
k) completing the study course by the student in accordance with the study guide;
l) completing the examination program by the student for establishing an examination result;
m) grading of the examination result for establishing academic credit; and
n) issuing a grade and credit.

15. The method of claim 14 wherein in step (b) the subject-related research materials are selected from t

16. The method of claim 14 wherein in step (e) the preparation of the course outline includes the step of listing the study materials, a sequence of study activities, an estimated time duration required for each of the study activities and for the course per se, and a summary of student proficiency expectation upon course completion and how such proficiency relates to at least one beneficial accreditation scale.

17. The method of claim 14 wherein the preparation of the study materials of step (f) include the incorporating of the materials into at least one of the group of information sources comprising: books, pamphlets, tapes, computer storage disks, photographs, manuscripts and Internet materials in a form for being used on-line and downloaded to computers on a computer network.

18. The method of claim 16 wherein in preparing the study guide of step (g) the method includes the listing of study materials, a proposed sequence of study activities formed as a proposal, the estimated time duration required for each of the study activities and for the course per se, an evaluation criteria sheet, a time log and a summary of student proficiency expectation upon course completion and how such proficiency relates to at least one beneficial accreditation scale.
